(19) United States
(12) Patent Application Publication
(10) Pub. No.: US 2023/0323042 A1
(43) Pub. Date: Oct. 12, 2023

(54) CALENDERED CELLULOSE ESTERS WITH LOW ACID GENERATION

(71) Applicant: Eastman Chemical Company, Kingsport, TN (US)

(72) Inventors: Robert Erik Young, Kingsport, TN (US); Michael Eugene Donelson, Kingsport, TN (US)

(73) Assignee: Eastman Chemical Company, Kingsport, TN (US)

(21) Appl. No.: 18/042,389

(22) PCT Filed: Aug. 16, 2021
(86) PCT No.: PCT/US2021/046110

§ 371 Date: Feb. 21, 2023

Related U.S. Application Data
(60) Provisional application No. 63/067,584, filed on Aug. 19, 2020.

(51) Int. Cl. C08J 3/20; C08K 5/134; C08K 5/11; B29C 43/24; C08K 5/101

(52) U.S. Cl. CPC C08J 3/203; C08K 5/1345; C08K 5/11; B29K 2001/08; C08K 5/101; C08J 2301/10; B29C 43/24

(57) ABSTRACT

The present application discloses a method of reducing acid and ester degradation products during calendering of cellulose ester containing plasticiser using certain additives such as primary antioxidants and metal alkanoate. The compositions comprising the additives exhibit significant reductions in acids and ester degradation products as compared to compositions not comprising the additives.

### BACKGROUND

Calendering offers some very attractive features, both from a performance and financial perspective, very few materials besides polyvinyl chloride, have the right combination of processing window, flow and metal release characteristics to be used in calendering.

Cellulose ester compositions are typically processed at temperatures above normal PVC processing temperatures. Higher processing temperatures can result in degradation of cellulose esters. At calendering temperatures, the rate of degradation is typically lower than other melt processes, but formulation components such as the cellulose ester resin or added plasticizers can still undergo degradation to form acids (e.g., acetic acid, propionic acid, butyric acid) or plasticizer degradation products. The degradation products can affect the processing of the compositions and cause the cellulose esters to undergo further acid catalyzed degradation. The degradation products can also volatilize during calendering.

A typical way of reducing acid by products formed during thermal processing of cellulose esters is to add acid scavengers such as bases (e.g., calcium carbonate). Applicants have discovered that certain additives such as primary antioxidants and metal alkanoates can reduce acid and additive degradation products formation during extrusion, calendering.

### SUMMARY OF THE INVENTION

The present application discloses a method, comprising:
(a) providing a blend comprising:
   (i) a cellulose ester,
   (ii) an additive which is a primary antioxidant, a metal (C₆₋₂₅)alkanoate or a combination, and
   (iii) a modifier which is a plasticizer, an impact modifier, or a combination
(b) forming a film, sheet, profile, or molded article comprising the blend.

The present application also discloses a 12. A method, comprising:
(a) feeding a cellulose ester; an additive which is a primary antioxidant, a metal (C₆₋₂₅)alkanoate, or a combination; and a modifier which is a plasticizer, an impact modifier, or a combination, to an extruder, a co-kneader, or heated high intensity batch mixer to form a blend;
(b) forming a film, sheet, or molded article comprising the blend.

### DETAILED DESCRIPTION OF THE INVENTION

In this specification and in the claims that follow, reference will be made to a number of terms, which shall be defined to have the following meanings.

Values may be expressed as “about” or “approximately” a given number. Similarly, ranges may be expressed herein as from “about” one particular value and/or to “about” or another particular value. When such a range is expressed, another aspect includes from the one value and/or to the other particular value. Similarly, when values are expressed as approximations, by use of the antecedent “about,” it will be understood that the particular value forms another aspect.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “includes,” and “include” have the same open-ended meaning as “comprising,” “comprises,” and “comprise” provided above.

A plasticizer is a substance added to a resin or polymer to improve the properties of the resin or polymer such as improving the plasticity, flexibility and brittleness. Examples of plasticizers suitable for use in this invention include: Abitol E, Permalyn 3100, Permalyn 2085, Permalyn 6110, Foralyn 110, Admex 523, Optifilm Enhancer 400, Uniplex 552, Uniplex 280, Uniplex 809, triphenylphosphate, tri(ethylene glycol)bis(2-ethylhexoate), tri(ethyleneglycol)bis(n-octanoate), diethyl phthalate, epoxidized soybean oil, dioctyl adipate, citrate esters, triacetin, tripropionin and combinations thereof.

“Degree of Substitution” is used to describe the substitution level of the substituents of the substituents per anhydroglucose unit (“AGU”). Generally, conventional cellulose contains three hydroxyl groups in each AGU that can be substituted. Therefore, the DS can have a value between 0 and 3. However, low molecular weight cellulose mixed esters can have a total degree of substitution slightly above 3 from end group contributions. Low molecular weight cellulose mixed esters are discussed in more detail subsequently in this disclosure. Because DS is a statistical mean value, a value of 1 does not assure that every AGU has a single substituent. In some cases, there can be unsubstituted anhydroglucose units, some with two and some with three substituents, and more often than not the value will be a noninteger. Total DS is defined as the average number of all of substituents per anhydroglucose unit. The degree of substitution per AGU can also refer to a particular substituent, such as, for example, hydroxyl, acetyl, butyryl, or propionyl. Additionally, the degree of substitution can specify which carbon unit of the anhydroglucose unit.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

The present description uses specific numerical values to quantify certain parameters relating to the invention, where the specific numerical values are not expressly part of a numerical range. It should be understood that each specific numerical value provided herein is to be construed as providing literal support for a broad, intermediate, and narrow range. The broad range associated with each specific numerical value is the numerical value plus and minus 60 percent of the numerical value, rounded to two significant digits. The intermediate range associated with each specific numerical value is the numerical value plus and minus 30 percent of the numerical value, rounded to two significant digits. The narrow range associated with each specific numerical value is the numerical value plus and minus 15 percent of the numerical value, rounded to two significant digits. For example, if the specification describes a specific temperature of 62° F., such a description provides literal support for a broad numerical range of 25° F. to 99° F. (62° F.+/−37° F.), an intermediate numerical range of 43° F. to 81° F. (62° F.+/−19° F.), and a narrow numerical range of 53° F. to 71° F. (62° F.+/−9° F.). These broad, intermediate, and narrow numerical ranges should be applied not only to the specific values, but should also be applied to differences between these specific values. Thus, if the specification describes a first pressure of 110 psia and a second pressure of 48 psia (a difference of 62 psi), the broad, intermediate, and narrow ranges for the pressure difference between these two streams would be 25 to 99 psi, 43 to 81 psi, and 53 to 71 psi, respectively.

Throughout this application, where patents or publications are referenced, the disclosures of these references in their entireties are intended to be incorporated by reference into this application, to the extent they are not inconsistent with the present invention, in order to more fully describe the state of the art to which the invention pertains.

Antioxidants are chemicals used to interrupt degradation processes during the processing of materials. Antioxidants are classified into several classes, including primary antioxidant, and secondary antioxidant.

“Primary antioxidants” are antioxidants that act by reacting with peroxide radicals via a hydrogen transfer to quench the radicals. Primary antioxidants generally contain reactive hydroxy or amino groups such as in hindered phenols and secondary aromatic amines. Examples of primary antioxidants include Irganox™ 1010, 1076, 1726, 245, 1098, 259, and 1425; Ethanox™ 310, 376, 314, and 330; Evernox™ 10, 76, 1335, 1330, 3114, MD 1024, 1098, 1726, 120. 2246, and 565; Anox™ 20, 29, 330, 70, IC-14, and 1315; Lowinox™ 520, 1790, 221646, 22M46, 44625, AH25, GP45, CA22, CPL, HD98, TBM-6, and WSP; Naugard™ 431, PS48, SP, and 445; Songnox™ 1010, 1024, 1035, 1076 CP, 1135 LQ, 1290 PW, 1330FF, 1330PW, 2590 PW, and 3114 FF; Tenox™ TBHQ, BHA, and BHT and ADK Stab AO-20, AO-30, AO-40, AO-50, AO-60, AO-80, and AO-330.

“Secondary antioxidants” are often called hydroperoxide decomposers. They act by reacting with hydroperoxides to decompose them into nonreactive and thermally stable products that are not radicals. They are often used in conjunction with primary antioxidants. Examples of secondary antioxidants include the organophosphorous (e.g., phosphites, phosphonites) and organosulfur classes of compounds. The phosphorous and sulfur atoms of these compounds react with peroxides to convert the peroxides into alcohols. Examples of secondary antioxidants include Ultranox 626, Ethanox™ 368, 326, and 327; Doverphos™ LPG11, LPG12, DP S-680, 4, 10, S480, and S-9228; Evernox™ 168 and 626; Irgafos™ 126 and 168 (tris(2,4-di-tert-butylphenyl)phosphite); Weston™ DPDP, DPP, EHDP, PDDP, TDP, TLP, and TPP; Mark™ CH 302, CH 55, TNPP, CH66, CH 300, CH 301, CH 302, CH 304, and CH 305; ADK Stab 2112, HP-10, PEP-8, PEP-36, 1178, 135A, 1500, 3010, C, and TPP; Weston 439, DHOP, DPDP, DPP, DPTDP, EHDP, PDDP, PNPG, PTP, PTP, TDP, TLP, TPP, 398, 399, 430, 705, 705T, TLTTP, and TNPP; Alkanox 240, 626, 626A, 627AV, 618F, and 619F; and Songnox™ 1680 FF, 1680 PW, and 6280 FF.

“Acid scavengers” are additives that neutralize acids formed during the processing of polymers. Examples of acid scavengers include Hycite 713; Kisuma DHT-4A, DHT-4V, DHT-4A-2, DHT-4C, ZHT-4V, and KW2200; Brueggemann Chemical Zinc Carbonate RAC; Sipax™ AC-207; calcium stearate; Baerlocher GL 34, RSN, GP, and LA Veg; Licomont CAV 102; FACI Calcium Stearate DW, PLC, SP, and WLC; Hangzhou Hitech Fine Chemical: CAST, and ZnST; Songstab™ SC-110, SC-120, SC-130, SM-310, and SZ-210; Sun Ace SAK-CS, SAK-DSC, SAK-DMS, SAK-DZS, and SAK-KS; US Zinc Zinc Oxide 201, 205 HAS, 205H, 210, and 210E; Drapex™ 4.4, 6.8, 39, 391, 392, and 392S; Vikoflex™ 4050, 5075, 7170, 7190, 7040, 9010, 9040, and 9080; Joncryl™ ADR 4468, and ADR 4400; Adeka CIZER D-32; Epon™ 1001F, 1002F, and 1007F; Aralidite™ ECN 1299, 1273, 1280, 1299, and 9511; Dynamar RC 5251Q; and Nexamite PBO.

As used herein the term “chosen from” when used with “and” or “or” have the following meanings: A variable chosen from A, B and C means that the variable can be A alone, B alone, or C alone. A variable A, B, or C means that the variable can be A alone, B alone, C alone, A and B in combination, A and C in combination, or A, B, and C in combination.

The present application discloses a method, comprising: (a) providing a blend comprising: (i) a cellulose ester, (ii) an additive which is a primary antioxidant, a metal (C₆₋₂₅)alkanoate or a combination, and (iii) a modifier which is a plasticizer, an impact modifier, or a combination; (b) forming a film, sheet, or molded article comprising the blend.

In one embodiment or in combination with any of the mentioned embodiments, the cellulose ester comprises a cellulose acetate, a cellulose propionate, a cellulose acetate propionate, a cellulose butyrate, a cellulose acetate butyrate, or a cellulose propionate butyrate. In one class of this embodiment, the additive is a primary antioxidant. In one subclass of this class, the primary antioxidant is pentaerythritol tetrakis(3-(3,5-di-tert-butyl-4-hydroxyphenyl)propionate), butylated hydroxyanisole, or butylated hydroxytoluene. In one sub-subclass of this subclass, the blend further comprises a secondary antioxidant. In one sub-sub-subclass of this sub-subclass, the secondary antioxidant is tris(2,4-di-tert-butylphenyl)phosphite.

In one class of this embodiment, the additive is the metal (C₆₋₂₅)alkanoate. In one subclass of this class, the metal (C₆₋₂₅)alkanoate is calcium stearate.

In one embodiment or in combination with any of the mentioned embodiments, the cellulose ester comprises the cellulose acetate. In one class of this embodiment, the additive is the primary antioxidant. In one subclass of this class, the primary antioxidant is pentaerythritol tetrakis(3-(3,5-di-tert-butyl-4-hydroxyphenyl)propionate), butylated hydroxyanisole, or butylated hydroxytoluene. In one sub-subclass of this subclass, the blend further comprises a secondary antioxidant. In one sub-sub-subclass of this sub-subclass, the secondary antioxidant is tris(2,4-di-tert-butylphenyl)phosphite.

In one class of this embodiment, the additive is the metal (C₆₋₂₅)alkanoate. In one subclass of this class, the metal (C₆₋₂₅)alkanoate is calcium stearate.

In one embodiment or in combination with any of the mentioned embodiments, the cellulose ester comprises the cellulose propionate. In one class of this embodiment, the additive is the primary antioxidant. In one subclass of this class, the primary antioxidant is pentaerythritol tetrakis(3-(3,5-di-tert-butyl-4-hydroxyphenyl)propionate), butylated hydroxyanisole, or butylated hydroxytoluene. In one sub-subclass of this subclass, the blend further comprises a secondary antioxidant. In one sub-sub-subclass of this sub-subclass, the secondary antioxidant is tris(2,4-di-tert-butylphenyl)phosphite.

In one class of this embodiment, the additive is the metal (C₆₋₂₅)alkanoate. In one subclass of this class, the metal (C₆₋₂₅)alkanoate is calcium stearate.

In one embodiment or in combination with any of the mentioned embodiments, the cellulose ester comprises the cellulose acetate propionate. In one class of this embodiment, the additive is the primary antioxidant. In one subclass of this class, the primary antioxidant is pentaerythritol tetrakis(3-(3,5-di-tert-butyl-4-hydroxyphenyl)propionate), butylated hydroxyanisole, or butylated hydroxytoluene. In one sub-subclass of this subclass, the blend further comprises a secondary antioxidant. In one sub-sub-subclass of this sub-subclass, the secondary antioxidant is tris(2,4-di-tert-butylphenyl)phosphite.

In one class of this embodiment, the additive is the metal (C₆₋₂₅)alkanoate. In one subclass of this class, the metal (C₆₋₂₅)alkanoate is calcium stearate.

In one embodiment or in combination with any of the mentioned embodiments, the cellulose ester comprises the cellulose butyrate. In one class of this embodiment, the additive is the primary antioxidant. In one subclass of this class, the primary antioxidant is pentaerythritol tetrakis(3-(3,5-di-tert-butyl-4-hydroxyphenyl)propionate), butylated hydroxyanisole, or butylated hydroxytoluene. In one sub-subclass of this subclass, the blend further comprises a secondary antioxidant. In one sub-sub-subclass of this sub-subclass, the secondary antioxidant is tris(2,4-di-tert-butylphenyl)phosphite.

In one class of this embodiment, the additive is the metal (C₆₋₂₅)alkanoate. In one subclass of this class, the metal (C₆₋₂₅)alkanoate is calcium stearate.

In one embodiment or in combination with any of the mentioned embodiments, the cellulose ester comprises the cellulose acetate butyrate. In one class of this embodiment, the additive is the primary antioxidant. In one subclass of this class, the primary antioxidant is pentaerythritol tetrakis(3-(3,5-di-tert-butyl-4-hydroxyphenyl)propionate), butylated hydroxyanisole, or butylated hydroxytoluene. In one sub-subclass of this subclass, the blend further comprises a secondary antioxidant. In one sub-sub-subclass of this sub-subclass, the secondary antioxidant is tris(2,4-di-tert-butylphenyl)phosphite.

In one class of this embodiment, the additive is the metal (C₆₋₂₅)alkanoate. In one subclass of this class, the metal (C₆₋₂₅)alkanoate is calcium stearate.

In one embodiment or in combination with any of the mentioned embodiments, the cellulose ester comprises the cellulose propionate butyrate. In one class of this embodiment, the additive is the primary antioxidant. In one subclass of this class, the primary antioxidant is pentaerythritol tetrakis(3-(3,5-di-tert-butyl-4-hydroxyphenyl)propionate), butylated hydroxyanisole, or butylated hydroxytoluene. In one sub-subclass of this subclass, the blend further comprises a secondary antioxidant. In one sub-sub-subclass of this sub-subclass, the secondary antioxidant is tris(2,4-di-tert-butylphenyl)phosphite.

In one class of this embodiment, the additive is the metal (C₆₋₂₅)alkanoate. In one subclass of this class, the metal (C₆₋₂₅)alkanoate is calcium stearate.

In one embodiment or in combination with any of the mentioned embodiments, the additive is a primary antioxidant.

In one class of this embodiment, the primary antioxidant is present at from 0.05 to 2 wt % based on the total weight of the composition. In one class of this embodiment, the primary antioxidant is present at from 0.05 to 1.5 wt % based on the total weight of the composition. In one class of this embodiment, the primary antioxidant is present at from 0.05 to 1 wt % based on the total weight of the composition. In one class of this embodiment, the primary antioxidant is present at from 0.05 to 0.8 wt % based on the total weight of the composition. In one class of this embodiment, the primary antioxidant is present at from 0.05 to 0.5 wt % based on the total weight of the composition. In one class of this embodiment, the primary antioxidant is present at from 0.05 to 0.3 wt % based on the total weight of the composition. In one class of this embodiment, the primary antioxidant is present at from 0.05 to 0.2 wt % based on the total weight of the composition.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the primary antioxidant comprises pentaerythritol tetrakis(3-(3,5-di-tert-butyl-4-hydroxyphenyl)propionate), a butylated hydroxyanisole, a butylated hydroxytoluene or combinations. In one class of this embodiment, the primary antioxidant is present at from 0.05 to 2 wt % based on the total weight of the composition. In one class of this embodiment, the primary antioxidant is present at from 0.05 to 1.5 wt % based on the total weight of the composition. In one class of this embodiment, the primary antioxidant is present at from 0.05 to 1 wt % based on the total weight of the composition. In one class of this embodiment, the primary antioxidant is present at from 0.05 to 0.8 wt % based on the total weight of the composition. In one class of this embodiment, the primary antioxidant is present at from 0.05 to 0.5 wt % based on the total weight of the composition. In one class of this embodiment, the primary antioxidant is present at from 0.05 to 0.3 wt % based on the total weight of the composition. In one class of this embodiment, the primary antioxidant is present at from 0.05 to 0.2 wt % based on the total weight of the composition.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0%. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the primary antioxidant comprises pentaerythritol tetrakis(3-(3,5-di-tert-butyl-4-hydroxyphenyl)propionate). In one class of this embodiment, the primary antioxidant is present at from 0.05 to 2 wt % based on the total weight of the composition. In one class of this embodiment, the primary antioxidant is present at from 0.05 to 1.5 wt % based on the total weight of the composition. In one class of this embodiment, the primary antioxidant is present at from 0.05 to 1 wt % based on the total weight of the composition. In one class of this embodiment, the primary antioxidant is present at from 0.05 to 0.8 wt % based on the total weight of the composition. In one class of this embodiment, the primary antioxidant is present at from 0.05 to 0.5 wt % based on the total weight of the composition. In one class of this embodiment, the primary antioxidant is present at from 0.05 to 0.3 wt % based on the total weight of the composition. In one class of this embodiment, the primary antioxidant is present at from 0.05 to 0.2 wt % based on the total weight of the composition.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the primary antioxidant comprises butylated hydroxyanisole. In one class of this embodiment, the primary antioxidant is present at from 0.05 to 2 wt % based on the total weight of the composition. In one class of this embodiment, the primary antioxidant is present at from 0.05 to 1.5 wt % based on the total weight of the composition. In one class of this embodiment, the primary antioxidant is present at from 0.05 to 1 wt % based on the total weight of the composition. In one class of this embodiment, the primary antioxidant is present at from 0.05 to 0.8 wt % based on the total weight of the composition. In one class of this embodiment, the primary antioxidant is present at from 0.05 to 0.5%. In one class of this embodiment, the primary antioxidant is present at from 0.05 to 0.3 wt % based on the total weight of the composition. In one class of this embodiment, the primary antioxidant is present at from 0.05 to 0.2 wt % based on the total weight of the composition.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the primary antioxidant comprises butylated hydroxytoluene. In one class of this embodiment, the primary antioxidant is present at from 0.05 to 2 wt % based on the total weight of the composition. In one class of this embodiment, the primary antioxidant is present at from 0.05 to 1.5 wt % based on the total weight of the composition. In one class of this embodiment, the primary antioxidant is present at from 0.05 to 1 wt % based on the total weight of the composition. In one class of this embodiment, the primary antioxidant is present at from 0.05 to 0.8 wt % based on the total weight of the composition. In one class of this embodiment, the primary antioxidant is present at from 0.05 to 0.5 wt % based on the total weight of the composition. In one class of this embodiment, the primary antioxidant is present at from 0.05 to 0.3 wt % based on the total weight of the composition. In one class of this embodiment, the primary antioxidant is present at from 0.05 to 0.2 wt % based on the total weight of the composition.

In one class of this embodiment, the primary antioxidant is present at no more than 1%. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the metal (C₆₋₂₅)alkanoate sodium stearate, potassium stearate, magnesium stearate, calcium stearate, or a combination.

In one class of this embodiment, the metal (C₆₋₂₅)alkanoate is present at from 0.05 to 2 wt % based on the total weight of the composition. In one class of this embodiment, the metal (C₆₋₂₅)alkanoate is present at from 0.05 to 1.5 wt % based on the total weight of the composition. In one class of this embodiment, the metal (C₆₋₂₅)alkanoate is present at from 0.05 to 1 wt % based on the total weight of the composition. In one class of this embodiment, the metal (C₆₋₂₅)alkanoate is present at from 0.05 to 0.8 wt % based on the total weight of the composition. In one class of this embodiment, the metal (C₆₋₂₅)alkanoate is present at from 0.05 to 0.5 wt % based on the total weight of the composition. In one class of this embodiment, the metal (C₆₋₂₅)alkanoate is present at from 0.05 to 0.3%. In one class of this embodiment, the metal (C₆₋₂₅)alkanoate is present at from 0.05 to 0.2 wt % based on the total weight of the composition.

In one embodiment or in combination with any of the mentioned embodiments, the metal (C₆₋₂₅)alkanoate is sodium stearate.

In one class of this embodiment, the metal (C₆₋₂₅)alkanoate is present at from 0.05 to 2 wt % based on the total weight of the composition. In one class of this embodiment, the metal (C₆₋₂₅)alkanoate is present at from 0.05 to 1.5 wt % based on the total weight of the composition. In one class of this embodiment, the metal (C₆₋₂₅)alkanoate is present at from 0.05 to 1 wt % based on the total weight of the composition. In one class of this embodiment, the metal (C₆₋₂₅)alkanoate is present at from 0.05 to 0.8 wt % based on the total weight of the composition. In one class of this embodiment, the metal (C₆₋₂₅)alkanoate is present at from 0.05 to 0.5 wt % based on the total weight of the composition. In one class of this embodiment, the metal (C₆₋₂₅)alkanoate is present at from 0.05 to 0.3 wt % based on the total weight of the composition. In one class of this embodiment, the metal (C₆₋₂₅)alkanoate is present at from 0.05 to 0.2 wt % based on the total weight of the composition.

In one embodiment or in combination with any of the mentioned embodiments, the metal (C₆₋₂₅)alkanoate is potassium stearate.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the metal (C₆₋₂₅)alkanoate is magnesium stearate.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the metal (C₆₋₂₅)alkanoate is calcium stearate.

In one class of this embodiment, the primary antioxidant is present at no more than 1%. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the metal (C₆₋₂₅)alkanoate is a combination comprising calcium stearate.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the metal (C₆₋₂₅)alkanoate is a combination comprising sodium stearate.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the metal (C₆₋₂₅)alkanoate is a combination comprising calcium stearate.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the modifier is the plasticizer. In one class of this embodiment, the plasticizer comprises triethylene glycol bis (2-ethylhexanoate.

In one embodiment or in combination with any of the mentioned embodiments, the modifier is the impact modifier.

In one embodiment or in combination with any of the mentioned embodiments, the blend further comprises a secondary antioxidant. In one class of this embodiment, the secondary antioxidant is tris(2,4-di-tert-butylphenyl)phosphite.

In one embodiment or in combination with any of the mentioned embodiments, the blend is formed in the extruder. In one embodiment, the blend is formed in the co-kneader. In one embodiment, the blend is formed in the heated high intensity batch mixer.

In one embodiment or in combination with any of the mentioned embodiments, the forming of the film, sheet, or molded article is performed at from 150° C. to 250° C. In one class of this embodiment, the article that is formed is a film or a sheet, and the forming occurs using a calender. In one class of this embodiment, the article that is formed is a molded article.

In one embodiment or in combination with any of the mentioned embodiments, the forming of the film, sheet, or molded article is performed at from 150° C. to 210° C. In one class of this embodiment, the article that is formed is a film or a sheet, and the forming occurs using a calender. In one class of this embodiment, the article that is formed is a molded article.

In one embodiment or in combination with any of the mentioned embodiments, the forming of the film, sheet, or molded article is performed at from 150° C. to 190° C. In one class of this embodiment, the article that is formed is a film or a sheet, and the forming occurs using a calender. In one class of this embodiment, the article that is formed is a molded article.

In one embodiment or in combination with any of the mentioned embodiments, the forming of the film, sheet, or molded article is performed at from 150° C. to 180° C. In one class of this embodiment, the article that is formed is a film or a sheet, and the forming occurs using a calender. In one class of this embodiment, the article that is formed is a molded article.

In one embodiment or in combination with any of the mentioned embodiments, the forming of the film, sheet, or molded article is performed at from 200° C. to 250° C. In one class of this embodiment, the article that is formed is a film or a sheet, and the forming occurs using a calender. In one class of this embodiment, the article that is formed is a molded article.

In one embodiment or in combination with any of the mentioned embodiments, during the forming step, acid generation is reduced by at least 60% relative to a dry blend not comprising the additive. In one embodiment or in combination with any of the mentioned embodiments, during the forming step, acid generation is reduced by at least 70% relative to a dry blend not comprising the additive. In one embodiment or in combination with any of the mentioned embodiments, during the forming step, acid generation is reduced by at least 80% relative to a dry blend not comprising the additive. In one embodiment or in combination with any of the mentioned embodiments, during the forming step, acid generation is reduced by at least 90% relative to a dry blend not comprising the additive. In one embodiment or in combination with any of the mentioned embodiments, during the forming step, acid generation is reduced by at least 92% relative to a dry blend not comprising the additive. In one embodiment or in combination with any of the mentioned embodiments, during the forming step, acid generation is reduced by at least 95% relative to a dry blend not comprising the additive. In one embodiment or in combination with any of the mentioned embodiments, during the forming step, acid generation is reduced by at least 97% relative to a dry blend not comprising the additive. In one embodiment or in combination with any of the mentioned embodiments, during the forming step, acid generation is reduced by at least 99% relative to a dry blend not comprising the additive.

The present application discloses a method, comprising: (a) feeding a cellulose ester; an additive which is a primary antioxidant, a metal (C₆₋₂₅)alkanoate, or a combination; and a modifier which is a plasticizer, an impact modifier, or a combination, to an extruder, a co-kneader, or heated high intensity batch mixer to form a blend; (b) forming a film, sheet, or molded article comprising the blend.

In one embodiment or in combination with any of the mentioned embodiments, the cellulose ester comprises a cellulose acetate, a cellulose propionate, a cellulose acetate propionate, a cellulose butyrate, a cellulose acetate butyrate, or a cellulose propionate butyrate. In one class of this embodiment, the additive is a primary antioxidant. In one subclass of this class, the primary antioxidant is pentaerythritol tetrakis(3-(3,5-di-tert-butyl-4-hydroxyphenyl)propionate), butylated hydroxyanisole, or butylated hydroxytoluene. In one sub-subclass of this subclass, the blend further comprises a secondary antioxidant. In one sub-sub-subclass of this sub-subclass, the secondary antioxidant is tris(2,4-di-tert-butylphenyl)phosphite.

In one class of this embodiment, the additive is the metal (C₆₋₂₅)alkanoate. In one subclass of this class, the metal (C₆₋₂₅)alkanoate is calcium stearate.

In one embodiment or in combination with any of the mentioned embodiments, the cellulose ester comprises the cellulose acetate. In one class of this embodiment, the additive is the primary antioxidant. In one subclass of this class, the primary antioxidant is pentaerythritol tetrakis(3-(3,5-di-tert-butyl-4-hydroxyphenyl)propionate), butylated hydroxyanisole, or butylated hydroxytoluene. In one sub-subclass of this subclass, the blend further comprises a secondary antioxidant. In one sub-sub-subclass of this sub-subclass, the secondary antioxidant is tris(2,4-di-tert-butylphenyl)phosphite.

In one class of this embodiment, the additive is the metal (C₆₋₂₅)alkanoate. In one subclass of this class, the metal (C₆₋₂₅)alkanoate is calcium stearate.

In one embodiment or in combination with any of the mentioned embodiments, the cellulose ester comprises the cellulose propionate. In one class of this embodiment, the additive is the primary antioxidant. In one subclass of this class, the primary antioxidant is pentaerythritol tetrakis(3-(3,5-di-tert-butyl-4-hydroxyphenyl)propionate), butylated hydroxyanisole, or butylated hydroxytoluene. In one sub-subclass of this subclass, the blend further comprises a secondary antioxidant. In one sub-sub-subclass of this sub-subclass, the secondary antioxidant is tris(2,4-di-tert-butylphenyl)phosphite.

In one class of this embodiment, the additive is the metal (C₆₋₂₅)alkanoate. In one subclass of this class, the metal (C₆₋₂₅)alkanoate is calcium stearate.

In one embodiment or in combination with any of the mentioned embodiments, the cellulose ester comprises the cellulose acetate propionate. In one class of this embodiment, the additive is the primary antioxidant. In one subclass of this class, the primary antioxidant is pentaerythritol tetrakis(3-(3,5-di-tert-butyl-4-hydroxyphenyl)propionate), butylated hydroxyanisole, or butylated hydroxytoluene. In one sub-subclass of this subclass, the blend further comprises a secondary antioxidant. In one sub-sub-subclass of this sub-subclass, the secondary antioxidant is tris(2,4-di-tert-butylphenyl)phosphite.

In one class of this embodiment, the additive is the metal (C₆₋₂₅)alkanoate. In one subclass of this class, the metal (C₆₋₂₅)alkanoate is calcium stearate.

In one embodiment or in combination with any of the mentioned embodiments, the cellulose ester comprises the cellulose butyrate. In one class of this embodiment, the additive is the primary antioxidant. In one subclass of this class, the primary antioxidant is pentaerythritol tetrakis(3-(3,5-di-tert-butyl-4-hydroxyphenyl)propionate), butylated hydroxyanisole, or butylated hydroxytoluene. In one sub-subclass of this subclass, the blend further comprises a secondary antioxidant. In one sub-sub-subclass of this sub-subclass, the secondary antioxidant is tris(2,4-di-tert-butylphenyl)phosphite.

In one class of this embodiment, the additive is the metal (C₆₋₂₅)alkanoate. In one subclass of this class, the metal (C₆₋₂₅)alkanoate is calcium stearate.

In one embodiment or in combination with any of the mentioned embodiments, the cellulose ester comprises the cellulose acetate butyrate. In one class of this embodiment, the additive is the primary antioxidant. In one subclass of this class, the primary antioxidant is pentaerythritol tetrakis(3-(3,5-di-tert-butyl-4-hydroxyphenyl)propionate), butylated hydroxyanisole, or butylated hydroxytoluene. In one sub-subclass of this subclass, the blend further comprises a secondary antioxidant. In one sub-sub-subclass of this sub-subclass, the secondary antioxidant is tris(2,4-di-tert-butylphenyl)phosphite.

In one class of this embodiment, the additive is the metal (C₆₋₂₅)alkanoate. In one subclass of this class, the metal (C₆₋₂₅)alkanoate is calcium stearate.

In one embodiment or in combination with any of the mentioned embodiments, the cellulose ester comprises the cellulose propionate butyrate. In one class of this embodiment, the additive is the primary antioxidant. In one subclass of this class, the primary antioxidant is pentaerythritol tetrakis(3-(3,5-di-tert-butyl-4-hydroxyphenyl)propionate), butylated hydroxyanisole, or butylated hydroxytoluene. In one sub-subclass of this subclass, the blend further comprises a secondary antioxidant. In one sub-sub-subclass of this sub-subclass, the secondary antioxidant is tris(2,4-di-tert-butylphenyl)phosphite.

In one class of this embodiment, the additive is the metal (C₆₋₂₅)alkanoate. In one subclass of this class, the metal (C₆₋₂₅)alkanoate is calcium stearate.

In one embodiment or in combination with any of the mentioned embodiments, the additive is a primary antioxidant.

In one class of this embodiment, the primary antioxidant is present at from 0.05 to 2%. In one class of this embodiment, the primary antioxidant is present at from 0.05 to 1.5%. In one class of this embodiment, the primary antioxidant is present at from 0.05 to 1%. In one class of this embodiment, the primary antioxidant is present at from 0.05 to 0.8%. In one class of this embodiment, the primary antioxidant is present at from 0.05 to 0.5%. In one class of this embodiment, the primary antioxidant is present at from 0.05 to 0.3%. In one class of this embodiment, the primary antioxidant is present at from 0.05 to 0.2%.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the primary antioxidant comprises pentaerythritol tetrakis(3-(3,5-di-tert-butyl-4-hydroxyphenyl)propionate), a butylated hydroxyanisole, a butylated hydroxytoluene or combinations. In one class of this embodiment, the primary antioxidant is present at from 0.05 to 2 wt % based on the total weight of the composition. In one class of this embodiment, the primary antioxidant is present at from 0.05 to 1.5 wt % based on the total weight of the composition. In one class of this embodiment, the primary antioxidant is present at from 0.05 to 1 wt % based on the total weight of the composition. In one class of this embodiment, the primary antioxidant is present at from 0.05 to 0.8 wt % based on the total weight of the composition. In one class of this embodiment, the primary antioxidant is present at from 0.05 to 0.5 wt % based on the total weight of the composition. In one class of this embodiment, the primary antioxidant is present at from 0.05 to 0.3 wt % based on the total weight of the composition. In one class of this embodiment, the primary antioxidant is present at from 0.05 to 0.2 wt % based on the total weight of the composition.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the primary antioxidant comprises pentaerythritol tetrakis(3-(3,5-di-tert-butyl-4-hydroxyphenyl)propionate). In one class of this embodiment, the primary antioxidant is present at from 0.05 to 2 wt % based on the total weight of the composition. In one class of this embodiment, the primary antioxidant is present at from 0.05 to 1.5 wt % based on the total weight of the composition. In one class of this embodiment, the primary antioxidant is present at from 0.05 to 1 wt % based on the total weight of the composition. In one class of this embodiment, the primary antioxidant is present at from 0.05 to 0.8 wt % based on the total weight of the composition. In one class of this embodiment, the primary antioxidant is present at from 0.05 to 0.5 wt % based on the total weight of the composition. In one class of this embodiment, the primary antioxidant is present at from 0.05 to 0.3 wt % based on the total weight of the composition. In one class of this embodiment, the primary antioxidant is present at from 0.05 to 0.2 wt % based on the total weight of the composition.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the primary antioxidant comprises butylated hydroxyanisole. In one class of this embodiment, the primary antioxidant is present at from 0.05 to 2 wt % based on the total weight of the composition. In one class of this embodiment, the primary antioxidant is present at from 0.05 to 1.5 wt % based on the total weight of the composition. In one class of this embodiment, the primary antioxidant is present at from 0.05 to 1 wt % based on the total weight of the composition. In one class of this embodiment, the primary antioxidant is present at from 0.05 to 0.8 wt % based on the total weight of the composition. In one class of this embodiment, the primary antioxidant is present at from 0.05 to 0.5 wt % based on the total weight of the composition. In one class of this embodiment, the primary antioxidant is present at from 0.05 to 0.3 wt % based on the total weight of the composition. In one class of this embodiment, the primary antioxidant is present at from 0.05 to 0.2 wt % based on the total weight of the composition.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0%. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the primary antioxidant comprises butylated hydroxytoluene. In one class of this embodiment, the primary antioxidant is present at from 0.05 to 2 wt % based on the total weight of the composition. In one class of this embodiment, the primary antioxidant is present at from 0.05 to 1.5 wt % based on the total weight of the composition. In one class of this embodiment, the primary antioxidant is present at from 0.05 to 1 wt % based on the total weight of the composition. In one class of this embodiment, the primary antioxidant is present at from 0.05 to 0.8 wt % based on the total weight of the composition. In one class of this embodiment, the primary antioxidant is present at from 0.05 to 0.5 wt % based on the total weight of the composition. In one class of this embodiment, the primary antioxidant is present at from 0.05 to 0.3 wt % based on the total weight of the composition. In one class of this embodiment, the primary antioxidant is present at from 0.05 to 0.2 wt % based on the total weight of the composition.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the metal (C₆₋₂₅)alkanoate sodium stearate, potassium stearate, magnesium stearate, calcium stearate, or a combination.

In one class of this embodiment, the metal (C₆₋₂₅)alkanoate is present at from 0.05 to 2 wt % based on the total weight of the composition. In one class of this embodiment, the metal (C₆₋₂₅)alkanoate is present at from 0.05 to 1.5 wt % based on the total weight of the composition. In one class of this embodiment, the metal (C₆₋₂₅)alkanoate is present at from 0.05 to 1 wt % based on the total weight of the composition. In one class of this embodiment, the metal (C₆₋₂₅)alkanoate is present at from 0.05 to 0.8 wt % based on the total weight of the composition. In one class of this embodiment, the metal (C₆₋₂₅)alkanoate is present at from 0.05 to 0.5 wt % based on the total weight of the composition. In one class of this embodiment, the metal (C₆₋₂₅)alkanoate is present at from 0.05 to 0.3 wt % based on the total weight of the composition. In one class of this embodiment, the metal (C₆₋₂₅)alkanoate is present at from 0.05 to 0.2 wt % based on the total weight of the composition.

In one embodiment or in combination with any of the mentioned embodiments, the metal (C₆₋₂₅)alkanoate is sodium stearate.

In one class of this embodiment, the metal (C₆₋₂₅)alkanoate is present at from 0.05 to 2 wt % based on the total weight of the composition. In one class of this embodiment, the metal (C₆₋₂₅)alkanoate is present at from 0.05 to 1.5 wt % based on the total weight of the composition. In one class of this embodiment, the metal (C₆₋₂₅)alkanoate is present at from 0.05 to 1 wt % based on the total weight of the composition. In one class of this embodiment, the metal (C₆₋₂₅)alkanoate is present at from 0.05 to 0.8 wt % based on the total weight of the composition. In one class of this embodiment, the metal (C₆₋₂₅)alkanoate is present at from 0.05 to 0.5 wt % based on the total weight of the composition. In one class of this embodiment, the metal (C₆₋₂₅)alkanoate is present at from 0.05 to 0.3 wt % based on the total weight of the composition. In one class of this embodiment, the metal (C₆₋₂₅)alkanoate is present at from 0.05 to 0.2 wt % based on the total weight of the composition.

In one embodiment or in combination with any of the mentioned embodiments, the metal (C₆₋₂₅)alkanoate is potassium stearate.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the metal (C₆₋₂₅)alkanoate is magnesium stearate.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the metal (C₆₋₂₅)alkanoate is calcium stearate.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the metal (C₆₋₂₅)alkanoate is a combination comprising calcium stearate.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the metal (C₆₋₂₅)alkanoate is a combination comprising sodium stearate.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the metal (C₆₋₂₅)alkanoate is a combination comprising calcium stearate.

In one class of this embodiment, the primary antioxidant is present at no more than 1 wt % based on the total weight of the composition. In one class of this embodiment, the primary antioxidant is present at no more than 1.5 wt % based on the total weight of the composition. In one class of this embodiment, the primary antioxidant is present at no more than 2 wt % based on the total weight of the composition. In one class of this embodiment, the primary antioxidant is present at no more than 2.5 wt % based on the total weight of the composition. In one class of this embodiment, the primary antioxidant is present at no more than 3.0 wt % based on the total weight of the composition. In one class of this embodiment, the primary antioxidant is present at no more than 3.5 wt % based on the total weight of the composition. In one class of this embodiment, the primary antioxidant is present at no more than 4 wt % based on the total weight of the composition.

In one embodiment or in combination with any of the mentioned embodiments, the modifier is a plasticizer. In one class of this embodiment, the plasticizer comprises triethylene glycol bis (2-ethylhexanoate.

In one embodiment or in combination with any of the mentioned embodiments, the modifier is the impact modifier.

In one embodiment or in combination with any of the mentioned embodiments, the modifier is a combination of the plasticizer and the impact modifier.

In one embodiment or in combination with any of the mentioned embodiments, step (a) further comprises feeding a secondary antioxidant. In one class of this embodiment, the secondary antioxidant is tris(2,4-di-tert-butylphenyl)phosphite.

In one embodiment or in combination with any of the mentioned embodiments, the forming of the film, sheet, or molded article is performed at from 150° C. to 250° C. In one class of this embodiment, the article that is formed is a film or a sheet, and the forming occurs using a calender. In one class of this embodiment, the article that is formed is a molded article.

In one embodiment or in combination with any of the mentioned embodiments, the forming of the film, sheet, or molded article is performed at from 150° C. to 210° C. In one class of this embodiment, the article that is formed is a film or a sheet, and the forming occurs using a calender. In one class of this embodiment, the article that is formed is a molded article.

In one embodiment or in combination with any of the mentioned embodiments, the forming of the film, sheet, or molded article is performed at from 150° C. to 190° C. In one class of this embodiment, the article that is formed is a film or a sheet, and the forming occurs using a calender. In one class of this embodiment, the article that is formed is a molded article.

In one embodiment or in combination with any of the mentioned embodiments, the forming of the film, sheet, or molded article is performed at from 150° C. to 180° C. In one class of this embodiment, the article that is formed is a film or a sheet, and the forming occurs using a calender. In one class of this embodiment, the article that is formed is a molded article.

In one embodiment or in combination with any of the mentioned embodiments, the forming of the film, sheet, or molded article is performed at from 200° C. to 250° C. In one class of this embodiment, the article that is formed is a film or a sheet, and the forming occurs using a calender. In one class of this embodiment, the article that is formed is a molded article.

In one embodiment or in combination with any of the mentioned embodiments, during the forming step, acid generation is reduced by at least 60% relative to a dry blend not comprising the additive. In one embodiment or in combination with any of the mentioned embodiments, during the forming step, acid generation is reduced by at least 70% relative to a dry blend not comprising the additive. In one embodiment or in combination with any of the mentioned embodiments, during the forming step, acid generation is reduced by at least 80% relative to a dry blend not comprising the additive. v, during the forming step, acid generation is reduced by at least 90% relative to a dry blend not comprising the additive. In one embodiment or in combination with any of the mentioned embodiments, during the forming step, acid generation is reduced by at least 92% relative to a dry blend not comprising the additive. In one embodiment or in combination with any of the mentioned embodiments, during the forming step, acid generation is reduced by at least 95% relative to a dry blend not comprising the additive. In one embodiment or in combination with any of the mentioned embodiments, during the forming step, acid generation is reduced by at least 97% relative to a dry blend not comprising the additive. In one embodiment or in combination with any of the mentioned embodiments, during the forming step, acid generation is reduced by at least 99% relative to a dry blend not comprising the additive.

### SPECIFIC EMBODIMENTS

Embodiment 1. A method, comprising: (a) providing a blend comprising: (i) a cellulose ester, (ii) an additive which is a primary antioxidant, a metal (C₆₋₂₅)alkanoate or a combination, and (iii) a modifier which is a plasticizer, an impact modifier, or a combination; (b) forming a film, sheet, or molded article comprising the blend.

Embodiment 2. The method of Embodiment 1, wherein the additive is the primary antioxidant.

Embodiment 3. The method of Embodiment 2, wherein the primary antioxidant is pentaerythritol tetrakis(3-(3,5-di-tert-butyl-4-hydroxyphenyl)propionate), butylated hydroxyanisole, or butylated hydroxytoluene.

Embodiment 4. The method of any one of Embodiments 1-3, wherein the additive is a metal (C₆₋₂₅)alkanoate.

Embodiment 5. The method of Embodiment 4, wherein the metal (C₆₋₂₅)alkanoate is calcium stearate or ZP 4083.

Embodiment 6. The method of any one of Embodiments 1-5, wherein the additive is present at no more than 3%.

Embodiment 7. The method of any one of Embodiments 1-6, wherein the modifier is the plasticizer.

Embodiment 8. The method of Embodiment 7, wherein the plasticizer comprises triethylene glycol bis (2-ethylhexanoate).

Embodiment 9. The method of any one of Embodiments 1-6, wherein the modifier is the impact modifier.

Embodiment 10. The method of any one of Embodiment 1-9, wherein the blend further comprises a secondary antioxidant.

Embodiment 11. The method of any one of Embodiments 1-10, wherein during the forming step, acid generation is reduced by 90% relative to a blend not comprising the additive.

Embodiment 12. A method, comprising: (a) feeding a cellulose ester; an additive which is a primary antioxidant, a metal (C₆₋₂₅)alkanoate, or a combination; and a modifier which is a plasticizer, an impact modifier, or a combination, to an extruder, a co-kneader, or heated high intensity batch mixer to form a blend; (b) forming a film, sheet, or molded article comprising the blend.

Embodiment 13. The method of any one of Embodiments 12, wherein the additive is the primary antioxidant.

Embodiment 14. The method of Embodiment 13, wherein the primary antioxidant is pentaerythritol tetrakis(3-(3,5-di-tert-butyl-4-hydroxyphenyl)propionate), butylated hydroxyanisole, or butylated hydroxytoluene.

Embodiment 15. The method of Embodiment 12, wherein the additive is a metal (C₆₋₂₅)alkanoate.

Embodiment 16. The method of Embodiment 15, wherein the metal (C₆₋₂₅)alkanoate is calcium stearate.

Embodiment 17. The method of any one of Embodiments 12-16, wherein the additive is present at no more than 3%.

Embodiment 18. The method of any one of Embodiments 12-13, wherein the modifier is the plasticizer.

Embodiment 19. The method of Embodiment 18, wherein the plasticizer comprises triethylene glycol bis (2-ethylhexanoate.

Embodiment 20. The method of any one of Embodiments 12-17, wherein the modifier is the impact modifier.

Embodiment 21. The method of any one of Embodiments 12-20, wherein the blend further comprises a secondary antioxidant.

Embodiment 22. The method of any one of Embodiments 12-21, wherein the blend is formed in the extruder.

Embodiment 23. The method of any one of Embodiments 12-21, wherein the blend is formed in the co-kneader.

Embodiment 24. The method of any one of Embodiments 12-21, wherein the blend is formed in the heated high intensity batch mixer.

Embodiment 25. The method of any one of Embodiments 12-24, wherein during the forming step, acid generation is reduced by 90% relative to a dry blend not comprising the additive.

### EXPERIMENTALS

### Abbreviations

min is minute(s); ° C. is degree(s) Celsius; g is gram(s); rpm is revolutions per minute; mm is millimeter; μm is micron(s); GC is gas chromatography; MS is mass spectrometry; CAP is cellulose acetate propionate; cm is centimeter(s); mL is milliliter(s); N2 is molecular nitrogen; HS is headspace; sec is second(s); VOC is volatile organic compound(s); μg is microgram(s); PrOH is propionic acid; g is gram(s); RF is response factor(s); Me2EH is methyl 2-ethylhexanoate; HS is head space; ID is internal diameter

Eastman CAP 482-20 is available from Eastman Chemical Company, Paraloid K125 is available from Dow Chemical Company, Licowax OP from Clariant Corporation and Triethylene Glycol Bis (2-EthylHexanoate) (TEG2EH) available from Eastman Chemical Company (Plasticizer). Additives investigated included Irganox 1010 available from BASF, Irgafos 168 available from BASF, BHA and BHT available from Eastman Chemical Company, Drapex 4,4 and Drapex 6.8 available from Galata Chemicals, Vicoflex V7170 available from Arkema, Calcium Stearate available from Sigma Aldrich, Zinc Stearate available from Sigma Aldrich, Hycite 713 available from Clariant Corporation, Naftosafe ZP-4083 available from Chemson, Advera 401P available from Advera-PQ Corporation, and Alcamizer 93P available from Kisuma Chemicals.

In all examples, formulations were weighed on Toledo-Mettler top loading balance to a total mass of 240 g, placed in a Kitchen Aid mixing bowl and mixed for approximately 5 min. The powder blend was then charged into a Brabender Intellitorque mixer. The temperature was set at 170° C. and the mixing blades set at 60 rpm. The powder was melted and removed from the mixer after 6 min. Samples were then placed on a Dr. Collin Two Roll Mill. The front-roll temperature was set at 170° C. and the back-roll temperature was set at 165° C. and the roll gap at 0.35 mm. The material was processed with the front roll speed set at 20 rpm and removed from the mill after 4 min in a continuous film at approximately 0.010 inch (250 μm) and allowed to cool.

Samples were prepared and degradation products were analyzed using a headspace GC/MS method described below. Due to the high signal to noise ratio, methyl 2-ethylhexanoate and propionic acid were used as proxies for oxidation products and acid species respectively.

Each CAP sample sheet was cut from the center into about 1 cm×5 cm strips that (0.6-0.8 g) was weighed into a 20-mL standard HS vial sealed with a septum cap. The sample in HS vial was designed to be heated at 190° C. for 10 min. By this procedure, the internal HS vial was filled with ambient air. When a special study was performed by comparing the effects of thermal degradation under air and in N2 inert environments, the sample in HS vial was purged with a gentle jet of nitrogen from the bottom of the vial for several min and sealed immediately with a septum cap.

Analytical instruments employed were an Agilent G1888 HS autosampler, an Agilent 6890 GC, and an Agilent 5975 MS Detector (MSD). All prepared samples in HS vials were heated at 190° C. for 10 minutes, at end of the thermal treatment, 1.0-mL of the hot vapor phase sample was injected onto the inlet of the GC and any volatile compounds evolved were separated by using a DB-1301 capillary column with dimension of 60 meters×0.32 mm ID×1.0 μm film thickness (DB1301 polymer coating composed of 6% cyanopropylphenyl/94% dimethyl polysiloxane), and the individual component peaks were detected by using the MSD for identification and quantification. The GC separation method details are: inlet temperature 250° C., carrier gas type: helium, constant column flow mode at 1.1 mL/min, split ratio of 10, average linear velocity of 27 cm/sec, oven temperature program: initial temperature at 40° C. hold for 6 min, ramp at 10° C./min rate to reach 280° C. and hold at 280° C. for 20 min with a total run time of 50 min.

For qualitative analysis, each detected peak on the total ion chromatogram (TIC) of each sample was searched and identified by using the NIST and the Eastman internal built mass spectral libraries. The detected VOC evolved from the 190° C. for 10 min thermal process in the film/HS vials filled with air and N2 for the same sample were compares visually by using overlaid TIC on the same chromatographic scale. In addition, the same TIC overlaid comparison was performed on each sample with different additive(s) having potential reduction abilities for oxidative thermal degradation over the control sample without any additives to show the VOC reduction effects.

For quantification purposes, a liquid standard solution consisted of two major detected compounds was prepared, which contained 20,560 μg/g of methyl 2-ethylhexanoate and 23,446 μg/g of PrOH in MeOH. Multiple standard HS vials containing various amounts of this standard solution were prepared by weighing such as 0.006, 0.015, and 0.02 g and analyzed by the same method as for the samples for generating RF to calculate these two major VOC in all samples. An average RF (net total μg analyte per HS vial/TIC peak area) for each analyte was generated from multiple standard HS vials analyzed before and after sample analysis; the μg/g (or PPM) analyte concentration in a sample was calculated by using the corresponding TIC peak area×RF/sample weight (g) for each compound. It should be noted that this quantified PPM concentration represents μg of each analyte generated into the headspace from 1 g of film sample after it has been treated at 190° C. for 10 min under air or N2 environment, it is not the total VOC in the original sample.

The base formulation used for the study is Eastman CAP 482-20 with 22 wt % TEG2EH+2 wt % Paraloid K-125 processing aid, and 1 wt % Licowax OP Montan wax with the additives listed below. Table 1 shows the formulations with and without additives.

TABLE 1
Formulations Studied.

| Ex # | Additive (wt %) |
|---|---|
| 1 | — |
| 2 | Irganox 1010 (0.25) |
| 3 | Irganox 1010 (0.5) |
| 4 | Irgranox 1010 (1) |
| 5 | Irgranox 1010 (0.5), Irgafos 168 (0.15) |
| 6 | BHA (0.5) |
| 7 | BHT (0.5) |
| 8 | Irganox 1010 (1), Vikoflex 7170 (2) |
| 9 | Irganox 1010 (0.5), Irgafos 168 (0.15), |
| | Vikoflex 7170 (2) |
| 10 | Vikoflex 7170 (2) |
| 11 | Drapex 4,4 (2) |
| 12 | calcium stearate (2) |
| 13 | zinc stearate (2) |
| 14 | Hycite 713 (2) |
| 15 | Ca/Zn stabilizer Naftosafe ZP-4083 (2) |
| 16 | Advera 401P (2) |
| 17 | Alcamizer P92 (2) |

Table 2 provides results on the effect of additives on the degradation of the compositions. Acid reduction is calculated by the following formula:

Acid reduction %=(1−(propionic acid ppm sample/propionic acid ppm control))*100

For samples that are below the measured threshold of the instrument, a value of 50 was assumed and used in the calculation.

Ester reduction is calculated by the following formula:

Ester reduction %=(1−(methyl 2-ethyl hexanoate ppm sample/methyl 2-ethylhexanoate ppm control))*100.

For samples that are below the measured threshold of the instrument, a value of 5 was assumed and used in the calculation. The control is sample formulation 1 (no additive). The control is Ex 1 which does not comprise any additives.

TABLE 2
Additive Effects on Degradation

| | | | | Acid | Ester |
|---|---|---|---|---|---|
| | | PrOH | Me2EH | reduction | reduction |
| Ex # | Additive (wt %) | (ppm) | (ppm) | (%) | (%) |
| 1 | — | 1260 | 163 | 0 | 0 |
| 2 | Irganox 1010 (0.25) | <50 | <5 | 96% | 97% |
| 3 | Irganox 1010 (0.5) | <50 | <5 | 96% | 97% |
| 4 | Irganox 1010 (1) | <50 | <5 | 96% | 97% |
| 5 | Irganox 1010 (0.5), | <50 | <5 | 96% | 97% |
| | Irgafos 168 (0.15) | | | | |
| 6 | BHA (0.5) | <50 | <5 | 96% | 97% |
| 7 | BHT (0.5) | <50 | <5 | 96% | 97% |
| 8 | Irganox 1010 (1), | <50 | <5 | 96% | 97% |
| | Vikoflex 7170 (2) | | | | |
| 9 | Irganox 1010 (0.5), | <50 | <5 | 96% | 97% |
| | Irgafos 168 (0.15) | | | | |
| | Vikoflex 7170 (2) | | | | |
| 10 | Vikoflex 7170 (2) | 1199 | 143 | 5% | 12% |
| 11 | Drapex 4,4 (2) | 1115 | 133 | 11% | 18% |
| 12 | calcium stearate (2) | <50 | <5 | 96% | 97% |
| 13 | zinc stearate (2) | 1490 | 25 | −18% | 85% |
| 14 | Hycite 713 (2) | 599 | 60 | 52% | 63% |
| 15 | Ca/Zn stabilizer | 183 | 10 | 85% | 94% |
| | ZP-4083 (2) | | | | |
| 16 | Advera 401P (2) | 675 | 63 | 46% | 61% |
| 17 | Alcamizer P92 (2) | 1157 | 113 | 8% | 31% |

The reduction of acid (PrOH) and ester (Me2EH) species by the use of antioxidants in the formulation is shown by comparing the acid reduction % for Ex 2-4, 6, 7 to Ex 1. The reduction of acidic and ester species by the use of combinations of primary and secondary antioxidants in the formulation is shown by comparing the acid reduction % for Ex 5, 8, and 9 to Ex 1. The reduction of ester degradation products using acid scavengers is shown by comparing the ester reduction % for Ex 12-17 to Ex 1. The dual reduction of both acidic species and ester degradation using certain additives in the formulation is shown by comparing Ex 2-9, 12, and 14-16 to Ex 1. At least a 20% reduction in both the acid and the ester is observed.

### CLAIMS NOT LIMITED TO DISCLOSED EMBODIMENTS

Forms of the invention described above are to be used as illustration only, and should not be used in a limiting sense to interpret the scope of the present invention. Modifications to the embodiments, set forth above, could be readily made by those skilled in the art without departing from the spirit of the present invention. The inventors hereby state their intent to rely on the doctrine of equivalents to determine and assess the reasonably fair scope of the present invention as it pertains to any apparatus not materially departing from but outside the literal scope of the invention as set forth in the following claims.

1. A method, comprising:
(a) providing a blend comprising:
(i) a cellulose ester,
(ii) an additive which is a primary antioxidant, a metal (C₆₋₂₅)alkanoate or a combination, and
(iii) a modifier which is a plasticizer, an impact modifier, or a combination
(b) forming a film or sheet comprising the blend at a temperature of from 150° C. to 250° C. using a calendar.

2. The method of claim 1, wherein the additive is the primary antioxidant.

3. The method of claim 2, wherein the primary antioxidant is pentaerythritol tetrakis(3-(3,5-di-tert-butyl-4-hydroxyphenyl)propionate), butylated hydroxyanisole, or butylated hydroxytoluene.

4. The method of claim 1, wherein the additive is a metal (C₆₋₂₅)alkanoate.

5. The method of claim 4, wherein the metal (C₆₋₂₅)alkanoate is calcium stearate or ZP 4083.

6. The method of claim 1, wherein the additive is present at no more than 3%.

7. The method of claim 1, wherein the modifier is the plasticizer, and the plasticizer comprises triethylene glycol bis(2-ethylhexanoate).

8. The method of claim 1, wherein the modifier is the impact modifier.

9. The method of claim 1, wherein the blend further comprises a secondary antioxidant.

10. A method, comprising:
(a) feeding a cellulose ester; an additive which is a primary antioxidant, a metal (C₆₋₂₅)alkanoate, or a combination; and a modifier which is a plasticizer, an impact modifier, or a combination, to an extruder, a co-kneader, or heated high intensity batch mixer to form a blend;
(b) forming a film or sheet comprising the blend at a temperature of from 150° C. to 250° C. using a calendar.

11. The method of claim 10, wherein the additive is the primary antioxidant.

12. The method of claim 11, wherein the primary antioxidant is pentaerythritol tetrakis(3-(3,5-di-tert-butyl-4-hydroxyphenyl)propionate), butylated hydroxyanisole, or butylated hydroxytoluene.

13. The method of claim 12, wherein the additive is a metal (C₆₋₂₅)alkanoate.

14. The method of claim 13, wherein the metal (C₆₋₂₅)alkanoate is calcium stearate.

15. The method of claim 10, wherein the additive is present at no more than 3%.

16. The method of claim 10, wherein the modifier is the plasticizer, and the plasticizer comprises triethylene glycol bis (2-ethylhexanoate).

17. The method of claim 10, wherein the modifier is the impact modifier.

18. The method of claim 10, wherein the blend further comprises a secondary antioxidant.

19. The method of claim 10, wherein the blend is formed in the extruder, the co-kneader, or the heated high intensity batch mixer.

20. The method of claim 1, wherein during the forming step, acid generation is reduced by 90% relative to a dry blend not comprising the additive.
